(19) United States
(12) Patent Application Publication
(10) Pub. No.: US 2010/0194312 A1
(43) Pub. Date: Aug. 5, 2010

(54) LED Operating Room Light

(75) Inventors: Ulrich Bohn, Neuhausen (CH); Heinz Reichle, Tuttlingen (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: TRILUX GMBH & CO. KG, Arnsberg (DE)

(21) Appl. No.: 12/677,433

(22) PCT Filed: Sep. 5, 2008
(86) PCT No.: PCT/DE2008/001496

§ 371 Date: Mar. 10, 2010

(30) Foreign Application Priority Data
Sep. 10, 2007 (DE) 10 2007 042 646.3

(51) Int. Cl. H05B 39/04; F21V 1/00

(52) U.S. Cl. 315/313; 362/235

(57) ABSTRACT

An operating room light includes a light casing, a reflector and a lighting means, wherein the operating room light is in the form of a single-reflector light. To prevent the operation wound from drying out, it is proposed that LEDs, OLEDs or laser diodes are used as the lighting means. The operating heat occurring can be dissipated outwardly by way of heat conduction and given off to the environment, away from the patient, by heat transfer of material—air and/or by heat radiation.

### CROSS-REFERENCE TO RELATED APPLICATIONS

This application is a Section 371 of International Application No. PCT/DE2008/001496, filed Sep. 5, 2008, which was published in the German language on Mar. 19, 2009, under

International Publication No. WO 2009/033461 A1 and the disclosure of which is incorporated herein by reference.

### BACKGROUND OF THE INVENTION

The invention concerns an operating room (OP) light having a light casing, a reflector and a lighting means. Such operating room lights are preferably in the form of single-reflector lights with a centrally arranged lighting means. In principle, however, they can also be in the form of multi-reflector lights with a plurality of reflectors, in which case then a corresponding lighting means is associated with each reflector. Nowadays, preferably halogen or discharge lamps are used as the lighting means.

For an operating room of a hospital, such an operating room light provides a focusable light cone with a particularly high level of luminous density at the focal point. The lighting field diameter can be adapted in dependence on the operating area size, that is to say focused, to reduce dazzle effects due to surrounding tissue or covering cloths.

Existing operating room lights with lighting means in the form of halogen or discharge lamps radiate a relatively large amount of infrared light and thus heat, which can lead to the operating wound of a patient prematurely drying out. Therefore, infrared filters are used to suppress such infrared radiation.

### BRIEF SUMMARY OF THE INVENTION

Therefore, the technical object of the present invention is to develop an operating room light of the general kind set forth in such a way that the above-mentioned disadvantages are at least partially avoided. In particular, markedly reduced infrared radiation and thus as little heat as possible is radiated onto the operating room wound.

In accordance with the invention, that object is attained in that the lighting means include at least one LED, OLED or a laser diode. When using LEDs, preferably a plurality of LEDs or laser diodes are arranged at or on a carrier element preferably arranged in the region of the optical axis of the light. For focusing purposes that carrier element can be adapted to be displaceable along the optical axis. It is particularly advantageous for the carrier element to be made from a material which is a particularly good conductor of heat for dissipating the local heat to the side of the light, remote from the patient.

The use according to the invention of LEDs, OLEDs or laser diodes entails the advantage that those lighting means emit considerably less infrared light and thus less heat. The heat occurring at the base of the diodes can be transferred to the light casing away from the operation wound. In that case the light casing and the individual components of the operating room light are preferably of such a configuration that they have particularly advantageous heat-dissipating properties.

Preferably the LEDs, OLEDs or laser diodes are displaceable for focusing purposes, preferably along the optical axis. Displacement can also be effected by displacement of the carrier element.

In an advantageous embodiment the operating room light also has an auxiliary reflector provided at least with a reflector surface, which is adapted to reflect at least a part of the light emitted by the lighting means only in a selected spectral range, in particular a selected color. In the preferred embodiment the auxiliary reflector is in the form of a reflector ring which is arranged concentrically around the optical axis and which is disposed beneath the lighting means in the direction of the light exit opening. Preferably, that auxiliary reflector, for acquiring variable amounts of light, is also arranged displaceably along the optical axis of the lighting means. A suitable choice of color for the auxiliary reflector makes it possible to steplessly adjust color reproduction in a certain range. Thus the auxiliary reflector, for example for adding a red light component to the white LED light and thus to increase color reproduction, can have a red color.

For altering the color gradient, one or more transmission filters can be arranged around the lighting means. Those transmission filters, which are preferably in the form of hollow-cylindrical glass or plastic material bodies, extend in that case around the lighting means. Those transmission filters can be individually displaceable for selectively switching those transmission filters on or off and correspondingly changing the color gradient.

Alternatively, color mixing can also be achieved, for example by LEDs or groups of LEDs, which are of different colors.

To further improve the heat-dissipating properties the LEDs are displaceable on the heat-conducting carrier element, preferably along the optical axis. Preferably, the carrier element is in the form of a cylinder, with flat portions at the fixing locations of the LEDs. The heat-conducting carrier element can be for example in the form of an axially displaceable octahedron, on the outer peripheral surface of which the LEDs or OLEDs are arranged. In that way, the heat generated by the LEDs is distributed by heat conduction to a larger emission area. The carrier element is preferably connected to the light casing and/or the reflector, in which case the heat transfer surfaces are such that they ensure particularly good heat transfer by virtue of mechanically biased elements.

In particular, POWER LEDs of high power have the particular advantage of white light without IR emission. On the other hand, heat generation nonetheless occurs at the base of the LEDs, and that heat also has to be dissipated. The LED heat is thus transferred by way of the LED base to the carrier element and then has to be delivered to the environment by way of heat-conducting elements comprising, for example, silver, copper, aluminum or heat pipes. For that purpose, the operating room light has a heat-emitting element. That element which gives off heat to the environment is preferably of a large area and comprises a material having particularly good heat-conducting properties as, for example, silver, copper or aluminum. The carrier element and the heat-emitting element can be in the form of separate components.

To prevent heat transfer from the carrier element and/or the heat radiating element, heat insulators are fitted between it or them and the light casing or reflector.

A preferred embodiment with particularly good heat conduction or heat emission upwardly provides that only an outer reflector is arranged in a frame, which annularly surrounds the reflector at the edge of the opening, for the function of the light casing. A particularly simple structural configuration provides that the heat-emitting element and the reflector hood are in one piece.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a cross-sectional view on an enlarged scale of an operating room LED light according to an embodiment of the invention.

### DETAILED DESCRIPTION OF THE INVENTION

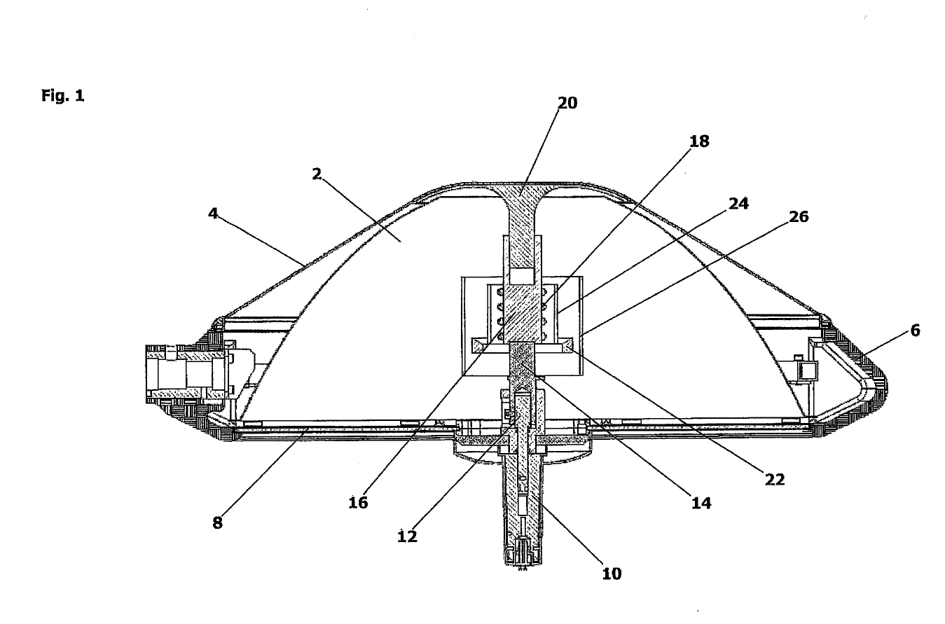

Accordingly, the operating room LED light comprises a dome-shaped and rotationally symmetrical inner reflector 2, which is preferably made in one piece from aluminum. The reflector 2 is enclosed by a reflector hood 4 whose edge which is the lower edge in the position of installation is fitted into a light casing, which in the present case is only in the form of a frame 6 and into which a carrier arm (not shown) for the operating room LED light can be laterally latched. The optical axis extends centrally vertically through the operating room LED light shown in the FIG. 1.

A light exit opening which is downward in the operating position is covered by a light cover in the form of a glass disk 8. A rotatable displacement handle 10 is arranged centrally in that glass disk 8, along the optical axis. Arranged in the upper end of that displacement handle 10 is a spindle 12, the upper end of which meshes rotatably into a cylindrical opening with a corresponding female screw thread of a spacer bar. Arranged on the top side of the spacer bar, which includes a heat insulator, is the substantially octahedric carrier 16 which, on its outer peripheral surface, has a series of LED rows 18 spaced vertically from each other and arranged in a ring configuration.

The upper end of the carrier element 16 is held vertically displaceably by a bar-shaped end, which projects downwardly in the position of installation, of a cap-shaped head portion 20. That mushroom-shaped head portion 20 makes contact with the heat-radiating or heat-emitting element (light cover). An improved embodiment provides a cylinder or connecting portion which projects downwardly in the position of installation and which displaceably surrounds the upper end of the carrier element 16.

A height-adjustable annular reflector 22 is arranged beneath the total of four rows 18 of LEDs. The reflector 22 has a reflection surface which is designed in dependence on the dimensions of the light (flat, convex, concave, at various angles to the horizontal). That annular reflector 22 is for example red in order to add red light to the white light emitted by the LEDs, in the shadow region of the displacement handle 10. Other light colors can be achieved by a suitable selection of the color of the annular reflector 22. In that way, the light emitted by the LED rows 18 is reflected only in a selected edge region in a given color and at a given angle.

Arranged between the annular reflector 22 and the carrier 16 carrying the LED rows 18 is a vertically displaceable inner transmission filter 24. That inner transmission filter is in the form of a hollow cylinder which surrounds the LED rows 18 and preferably comprises a colored material, in the present case yellow glass.

An outer transmission filter 26 is also arranged vertically displaceably outside that inner transmission filter 24 and the annular reflector 22, the outer transmission filter 26 comprising a colored hollow cylinder, which in the present case is blue. The inner transmission filter 24 and the outer transmission filter 26 are displaceable separately from each other along the optical axis for stepless adaptation of the color gradient.

The operating room light can be varied in brightness by switching individual LED rows 18 on and off, while maintaining the prevailing basic color in the operating room, while maintaining the color temperature and color reproduction. That is essential for a colored operating light which is as true to nature as possible, with a color reproduction index which is as high as possible, greater than 90.

In a simplified embodiment the reflector 2 and the reflector hood 4 can be in one piece.

It is important that the heat generated by the LED rows 18 at the base is carried away from the region of the operation by way of the carrier 16 by virtue of a suitable configuration for the operating room LED light.

The preferred embodiment of the operating room LED light provides for a change in the overall brightness of the light, insofar as only individual or given sections of the LEDs are switched off or on. Selectively switching off individual LEDs, which is proposed in accordance with the invention, in which case the others are switched on at full power, avoids the disadvantage of altering the color gradient upon a change in the power supply for the LEDs.

In accordance with the invention there is provided a novel operating room light which avoids the problems known from the state of the art by virtue of the operation wound drying out caused by infrared radiation, in that a plurality of LEDs or areal OLEDs are used as lighting means. The heat generated by the lighting means is emitted exclusively away from the patient by virtue of the structural configuration of the operating room light.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1-16. (canceled)

17. An operating room light comprising a reflector (2), a lighting means comprising at least one of a LED, an OLED and a laser diode, and an auxiliary reflector having at least one reflector surface adapted to reflect at least a part of the light emitted by the lighting means only in a selected spectral range (color), wherein the auxiliary reflector has a form of an annular reflector (22) surrounding the lighting means.

18. The operating room light according to claim 17, wherein the auxiliary reflector is displaceable along an optical axis of the lighting means.

19. The operating room light according to claim 17, wherein at least one transmission filter (24, 26) is arranged around the lighting means for changing a color gradient.

20. The operating room light according to claim 19, wherein the at least one transmission filter (22, 24) is arranged around the auxiliary reflector.

21. The operating room light according to claim 19, wherein the at least one transmission filter (24, 26) is displaceable.

22. The operating room light according to claim 21, comprising two of the transmission filters (24, 26) displaceable independently of each other.

23. The operating room light according to claim 17, wherein the lighting means is arranged on a heat-conducting carrier material.

24. The operating room light according claim 17, wherein the light is variable in brightness.

25. The operating room light according to claim 24, wherein a part of the lighting means can be switched off and on to alter the brightness.

26. The operating room light according to claim 17, wherein a heat-radiating surface entirely or partially represents a reflector hood (4).

27. The operating room light according to claim 17, wherein the lighting means is arranged on a heat conductor for dissipating operating heat outwardly.

28. The operating room light according to claim 27, wherein the heat conductor includes an outwardly heat-emitting element.

29. The operating room light according to claim 28, wherein the heat-emitting element has a form of a light cover.

30. The operating room light according to claim 17, wherein the light has a form of a single-reflector light.

31. A method for operating the operating room light of claim 17, wherein the lighting means includes at least a plurality of LEDs, the method comprising varying brightness of the light by selectively switching off and on individual ones of the LEDs and/or a row of the LEDs.
